(19) United States
(12) Patent Application Publication
(10) Pub. No.: US 2013/0141354 A1
(43) Pub. Date: Jun. 6, 2013

(54) IMAGE-CAPTURING TOUCH PANEL

(71) Applicant: Mei Ching TSAI, Taipei City (TW)

(72) Inventor: Mei Ching TSAI, Taipei City (TW)

(21) Appl. No.: 13/566,083

(22) Filed: Aug. 3, 2012

(30) Foreign Application Priority Data
Dec. 5, 2011 (TW) 100144628

(51) Int. Cl. G06F 3/041

(52) U.S. Cl. 345/173

(57) ABSTRACT

An image-capturing touch panel is disclosed, which comprises: a display device; a touch device locating at one side of the display device; and an image-capturing device locating at the other side of the display device, and the image-capturing device comprises multiple light-sensor units; wherein the display device and the image-capturing device are both in a shape of sheet and substantially have the same area, the light-sensor units are uniformly distributed in the image-capturing device, the display device and the image-capturing device are stacked to form a stack, and the display device and the image-capturing device are a transparent display device and a transparent image-capturing device respectively.

### CROSS REFERENCE TO RELATED APPLICATION

This application claims the benefits of the Taiwan Patent Application Serial Number 100144628, filed on Dec. 5, 2011, the subject matter of which is incorporated herein by reference.

### BACKGROUND OF THE INVENTION

1. Field of the Invention

The present invention relates to an image-capturing touch panel and, more particularly, to an image-capturing touch panel which allows light-penetration.

2. Description of Related Art

With the advancement of electronic components, multifunctional electronic devices have been developed to satisfy the requirement of the general population. Nowadays, electronic products such as display devices, all-in-one devices, mobile phones, PDAs (personal digital assistants), or tablet PCs are equipped with image-capturing devices. Since image-capturing devices may provide a variety of functions or portable devices such as image-identification, face-recognition, scene-recognition, gesture-recognition, or object-recognition, portable devices or data processing apparatus are now commonly equipped with image-capturing devices to enhance applicative capacity.

Moreover, touch-sensing portable devices are now progressively replacing keystroke-controlled devices. In some cases, when touch-sensing portable such as laptop equipped with conventional image-capturing device is used, a predetermined minimum distance between the image-capturing device and the object to be captured should be kept. If the distance between the object and the image-capturing device is less than the minimum predetermined distance, it would not be able to capture the image. For example, if a camera is placed directly on top of the printed papers, the image of the printed papers cannot be captured by the camera since there is no space (i.e. distance) in between the papers and the camera.

As shown in FIG. 1, a laptop named ‘Fujitsu Iris’ by Fujitsu co. has been developed by Fujitsu co., which is comprised of: an OLED panel 11, a touch-controlled layer 12, and a scanning bar 13 locating on the touch-controlled layer 12 for image-capturing and image-recognition. Though the scanning bar 13 provides scanning and image-capturing functions for the laptop, the whole size and weight of the laptop is increased, and the image quality differs when different movements of the users are applied, e.g. the image may be twisted or has low-legibility. Therefore, it is desirable to provide an improved image-capturing device to mitigate the aforementioned problems and create great commercial benefit.

### SUMMARY OF THE INVENTION

The present invention provides an image-capturing touch panel, which is comprised of: a display device; a touch device locating at one side of the display device; and an image-capturing device locating at the other side of the display device, and the image-capturing device comprises multiple light-sensor units; wherein the display device and the image-capturing device are both in the shape of sheet, the light-sensor units are uniformly distributed in the image-capturing device, the display device and the image-capturing device are stacked to form a stack, and the display device and the image-capturing device are transparent display device and transparent image-capturing device respectively.

The image-capturing touch panel of the present invention comprises an image-capturing device distributing at the whole surface of the display device, and therefore is able to provide very-short-distance image capturing. Specifically, the image-capturing touch panel of the present invention comprises an image-capturing device having light-sensor units distributing at the whole lower surface of the display device. In detail, for the image-capturing touch panel of the present invention, a touch device locates on the display device, the image-capturing device comprises multiple light-sensor units uniformly distributing on the surface of the stack so as to realize whole surface image capturing. Therefore, a scanning bar of a conventional laptop can be eliminated. The image-capturing touch panel of the present invention therefore has the advantage of being small in size, lightweight, compactness, etc, and may possess a higher economical value compared to the conventional touch displays.

According to the image-capturing touch panel of the present invention, preferably, the display device and the image-capturing device substantially have the same area.

According to the image-capturing touch panel of the present invention, the touch device is preferably a side-detection touch device locating at the corner of the display device. The side-detection touch device locating at the corner of the display device can be a block-shaped touch device, instead of a plate-shaped touch device covering the whole surface of the display device. For example, the side-detection touch device can be of any conventional touch device such as optical touch device, infrared touch device, or acoustic wave touch device, etc. Besides, the touch device may be a light-transmitting touch sensor, which can be stacked with the display device and the image-capturing device so that the display device locates between the touch device and the image-capturing device. Light-transmitting touch sensor can be any touch sensor of prior arts such as resistive touch sensor, capacitive touch sensor, or electromagnetic touch sensor, etc.

Preferably, the image-capturing touch panel of the present invention may further comprise a processing unit and a controlling unit.

Preferably, the image-capturing touch panel of the present invention may further comprise a camera module locating at a side of the stack. Preferably, the image-capturing touch panel of the present invention may further comprise a detecting unit for detecting the distance between the image-capturing touch panel and an object to be captured, the detecting unit determines either the camera module or the image-capturing device is operated, or the detecting unit detects the brightness of the environment, For example, when the detecting unit detects that the distance between the image-capturing touch panel and the object is less than a predetermined value, the controlling unit may command the image-capturing device to capture the image. In contrast, when the detecting unit detects that the distance between the image-capturing touch panel and the object is larger than a predetermined value, the controlling unit may command the camera module to capture the image. The detecting unit can detect environmental brightness so as to control the light source to emit light when the brightness of the environment is not enough. The light source can also be controlled manually, instead of being controlled by the detecting unit.

Preferably, the image-capturing touch panel of the present invention may further comprise a light-source locating at a side of the stack (e.g. locating on at least one corner or the edge of the stack) for providing lights, in which the detecting unit detects the brightness of the object to be captured and determines whether the light source is turned on or off. Since the image-capturing device is a light-transmitting image-capturing device, lights can transmit through the image-capturing device and reach the surface of the object such that the image-capturing device can capture the image of the object according to the light reflected by the object. When the brightness of the environment is not enough, the light source can provide some light to increase the brightness.

Preferably, the image-capturing touch panel of the present invention may further comprise a process controller locating on the side of the stack, and the process controller independently electrically connects to the touch device, the display device, and the image-capturing device.

According to the image-capturing touch panel of the present invention, the display device is a light-emitting diode display, and the light-emitting diode display comprises a substrate and multiple light-emitting diode units; or the display device is an organic light-emitting diode display.

According to the image-capturing touch panel of the present invention, the display device locates on a substrate, and the multiple light-sensor units of the image-capturing device locates on the substrate; or the display device locates on a first substrate, the image-capturing device locates on a second substrate, and the multiple light-sensor units of the image-capturing device locates on the second substrate.

According to the image-capturing touch panel of the present invention, the multiple light-sensor units may preferably be selected from CMOS (complementary metal oxide semiconductors) and CCD (charge-coupled device).

The above device, unit, or module such as camera module, detecting unit, process unit, image-capturing device, display device, touch device, and/or light source is connected to the controlling unit. When the processing unit transfers the received signal to the controlling unit, the controlling unit may control the action of the camera module, detecting unit, image-capturing device, display device, touch device, or light source

The image-capturing touch panel of the present invention may preferably further comprise a frame, which is set to surround the stack to protect the devices of the stack.

According to the image-capturing touch panel of the present invention, the surface area of the multiple light-sensor units is preferably 10% to 90% of the surface area of the image-capturing device.

According to the image-capturing touch panel of the present invention, the surface area of the display device is substantially the same as the surface area of the image-capturing device. As used herein, the term “substantially” refers to the complete or nearly complete extent or degree of an action, characteristic, property, state, structure, item, or result. For example, a “substantially” same surface area as another would mean that the surface area is either completely the same or nearly the same. The exact allowable degree of deviation from absolute completeness may in some cases depend on the specific context. However, generally speaking the closeness to completion will be deemed as to having the same overall result as if absolute and total completion were obtained.

The image-capturing touch panel according to the present invention may preferably be an electrical color-displaying device such as an electrical color card or electrical color chip, wherein when an object to be tested is placed under the image-capturing device, the color of the object is displayed by the display device.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional laptop by Fujitsu co;

FIG. 2 is a perspective view of an image-capturing touch panel of example 1 in the present invention;

FIG. 3 is a perspective view of a stack of the image-capturing touch panel of example 1 in the present invention;

FIG. 4 is a perspective view of a stack of the image-capturing touch panel of example 1 in the present invention;

FIG. 5 is a perspective view of an image-capturing touch panel of example 2 in the present invention;

FIG. 6 is a controller diagram of an image-capturing touch panel of example 2 in the present invention;

FIG. 7 is a schematic view showing the pixels of the light-sensor units in the image-capturing device of example 2 in the present invention;

FIG. 8 is a stereoscopic view of an image-capturing touch panel of example 3 in the present invention;

FIG. 9 is a stereoscopic view of an image-capturing touch panel of example 4 in the present invention;

FIG. 10 is a cross-sectional view of an image-capturing device and a display device of a preferred example in example 5 of the present invention; and

FIG. 11 is a cross-sectional view of an image-capturing device and a display device of another preferred example in example 5 of the present invention

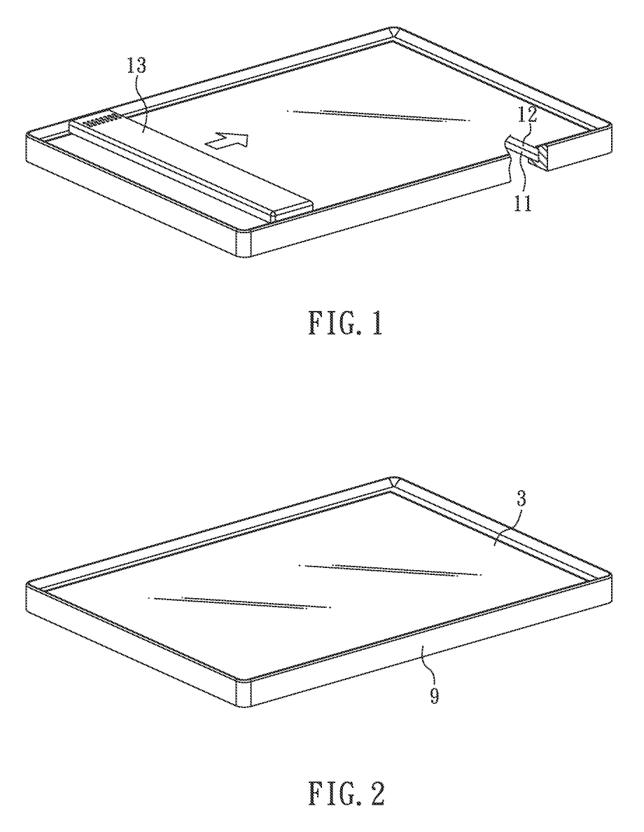

### DETAILED DESCRIPTION OF THE PREFERRED EMBODIMENT

### Example 1

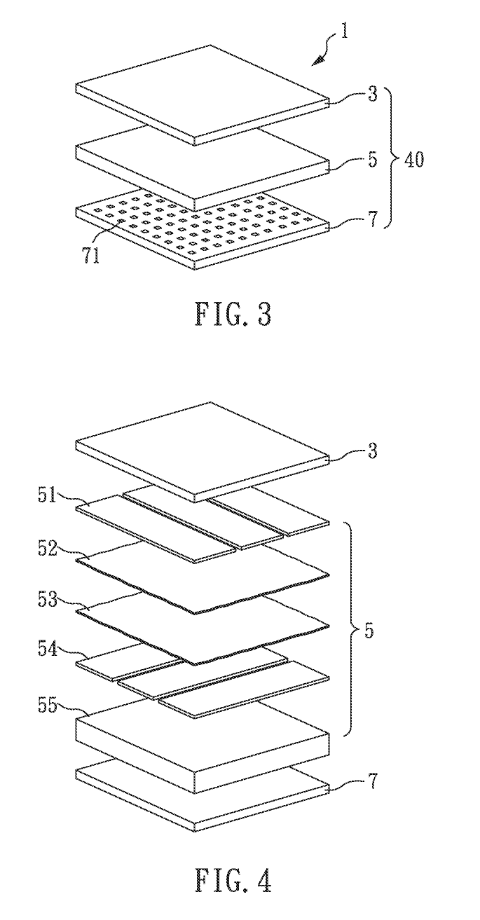

FIG. 2 shows a perspective view of an image-capturing touch panel of the present example, and FIGS. 3 and 4 are schematic diagrams showing the stack of the image-capturing touch panel of the present example.

As shown in FIG. 3, the image-capturing touch panel 1 comprises: a display device 5; a touch device 3 locating at one side of the display device 5; an image-capturing device 7 locating at the other side of the display device 5, and the image-capturing device 7 comprises multiple light-sensor units 71; and a frame 9, wherein the display device 5 and the image-capturing device 7 are both in a shape of sheet; the light-sensor units 71 are uniformly distributed in the image-capturing device 7; the touch device 3, the display device 5 and the image-capturing device 7 are stacked to form a stack 40; the display device 5 and the image-capturing device 7 are transparent display device and transparent image-capturing device respectively; and the frame 9 sets to surround the stack.

In the present example, the display device 5 and the image-capturing device 3 substantially have the same area. As used herein, the term “substantially” refers to the complete or nearly complete extent or degree of an action, characteristic, property, state, structure, item, or result. For example, a “substantially” same surface area as another would mean that the surface area is either completely the same or nearly the same, for example the difference between the surface areas may be within 5% or 10%.

In the present example, the display device 5 is an OLED (organic light-emitting diode) comprising: a cathode 51, an emitting layer 52, a conductive layer 53, an anode 54, and a substrate 55. The touch device 3 may be any capacitive touch sensor or optionally may be resistive touch sensor or electromagnetic touch sensor, etc. The display device 5 is not limited to OLED and may be any other transparent display device such as light-emitting diode or etc.

In the present example, the light-sensor units 71 of the image-capturing device 7 are CCDs (charge-coupled devices).

### Example 2

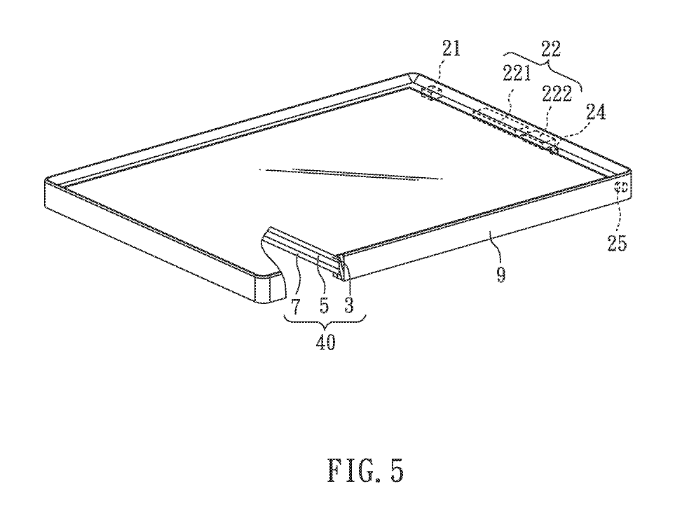

Referring to FIG. 5, a perspective view of an image-capturing touch panel of the present example is shown. In addition to the components which are the same as those of the image-capturing touch panel in example 1, the image-capturing touch panel of the present example further comprises: a camera module 21 locating at a side of the stack 40; a detecting unit 24 for detecting the distance between the image-capturing device and an object to be captured (not shown); a process controller 22 locating at a side of the stack 40, the process controller 22 comprises a process unit 222 and a controlling unit 221, and the process controller 22 is independently electrically connected to the touch device 3, the display device 5, and the image-capturing device 7; and a light source 25 located at least one side or both sides of the stack 40 for providing lights. For example, multiple light sources 25 arranged periodically with a predetermined interval at at least one side or two or more different sides of the stack 40, e.g. multiple light sources 25 arranged adjacent to the process controller 22 at same side of the stack 40, or in another example the multiple light sources 25 arranged at a side of the process controller 22 opposite to the process controller 22 (not shown).

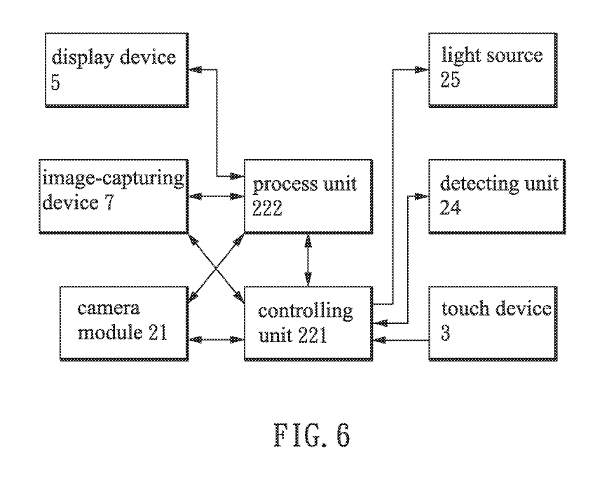

FIG. 6 shows a controller diagram of an image-capturing touch panel of example 2 in the present example. Referring to FIGS. 5 and 6, the devices, units, or modules such as camera module 21, detecting unit 24, process unit 222, image-capturing device 7, touch device 3, and light source 25 are connected to the controlling unit 221. A signal may be transferred between the controlling unit 221 and the processing unit 222, and the controlling unit 221 may control the camera module 21, the detecting unit 24, the image-capturing device 7, the light source 25, and the touch device 3 according to the signal.

For example, when the detecting unit 24 detects that the distance between the image-capturing touch panel and the object is less than a predetermined value, the controlling unit 221 may command the image-capturing device 7 to capture the image. Herein, the predetermined value is a minimum focus value of the camera module 21. In contrast, when the detecting unit 24 detects that the distance between the image-capturing touch panel and the object is larger than a predetermined value (e.g. a minimum focus value of the camera module 21), the controlling unit 221 may command the camera module 21 to capture the image. Herein, the operating switch between the image-capturing device 7 and the camera module 21 can also be controlled manually by the touch device 3, instead of being controlled by the detecting unit 24.

Furthermore, the detecting unit 24 can detect environmental brightness so as to enable the controlling unit 221 for controlling the light source 25 to emit light when the brightness of the environment is not enough. The light source 25 can be set at the inner or outer side of the frame or can be embedded in the frame, the light source 25 can locate at a side, a corner, or other position of the image-capturing device 7. The image-capturing device 7 is a transparent image-capturing device and therefore lights can be transferred through and reach the object and enable the image-capturing device 7 to capture the image of the object according to the light reflected by the object. The light source can also be controlled manually, instead of being controlled by the detecting unit 24.

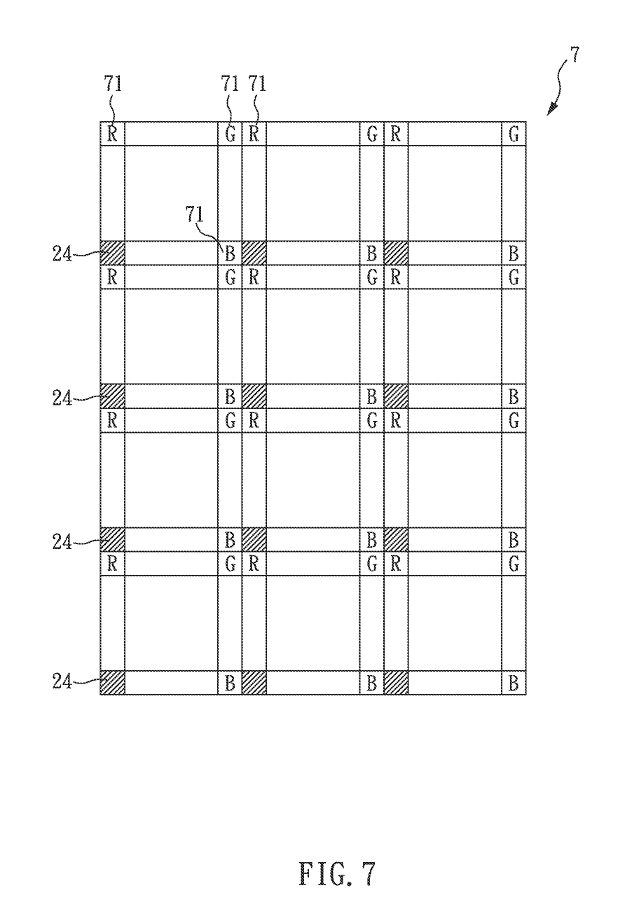

Referring to FIG. 7, the pixel distribution as well as the light-sensor units 71 of image-capturing device 7 is shown, wherein the light-sensor units 71 comprise a red-light sensor unit (R), a green-light sensor unit (C), and a blue-light sensor unit (B) for sensing red, green, and blue images respectively to complete image-capturing. The light-sensor units 71 can be in rectangular shapes and be arranged in an array or line; or be in hexagonal shapes and arranged staggered. The surface area (which relates to the aperture ratio of the image-capturing device) of the multiple light-sensor units 71 is preferably 10% to 90% of the total surface area of the image-capturing device so as to maintain a preferred transparency and an excellent image-capturing function. The aperture ratio of the image-capturing device is not specially limited to 10% to 90%, it may also be 0%-10% or 90%-100% which all falls in the scope of the present invention. Herein, the detecting unit 24 can also be set in the image-capturing device 7 for detecting distance and brightness.

### Example 3

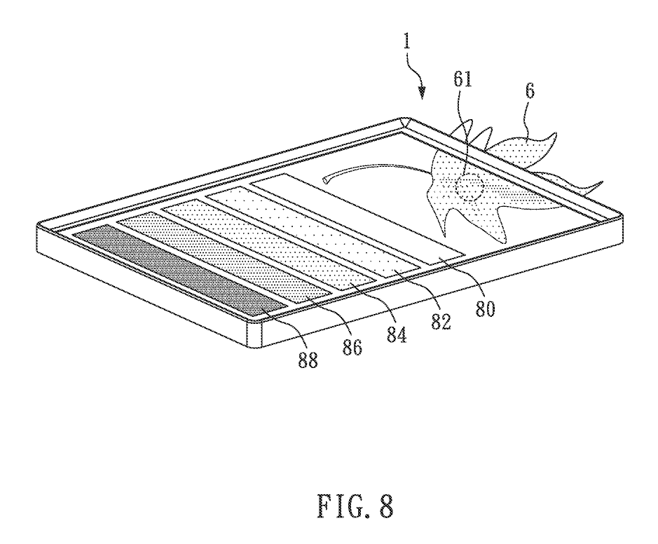

In FIG. 8, a perspective view of an image-capturing touch panel of the present example is shown. As shown in FIGS. 5, 6, and 8, the image-capturing touch panel 1 of the present example has the same basic component as that of example 2, except that the image-capturing touch panel 1 of the present example is served as an electrical color-displaying device such as an electrical color card or electrical color chip. When the object (e.g. a maple leaf 6 as shown in the FIG. 8) to be tested is placed under the image-capturing device 7, a color (e.g. the red color in the block 61 of the maple leaf 6) of the object is captured by the image-capturing device 7 and is transferred to the processing unit 222. The processing unit 222 controls the display device 5 to display color of the block 61 on the displaying block 84, and at the same time display a color gradient by the displaying blocks 80, 82, 86, and 88. Therefore, the users can check the color visually and select a displaying block that displays a preferred color by directly touching the image-capturing touch panel 1. Herein, the touch device 3 may determine the position touched by the user's fingers and transfer the information data to the processing unit 222 through the process controller 22, and therefore the processing unit 222 may determine which display block is selected and may store the data.

### Example 4

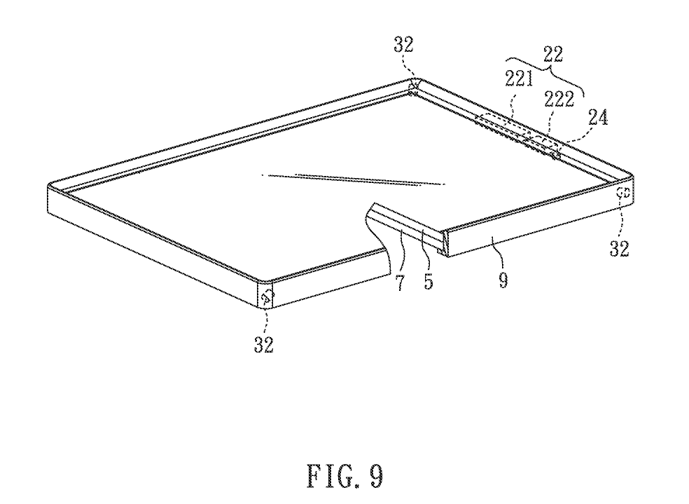

As shown in FIG. 9, the image-capturing touch panel of the present example is roughly the same as that of example 1, except that a side-detection touch device is used instead of the light-transmitting touch sensor. In detail, the present example uses infrared touch device for substituting the capacitive touch sensor to decrease total weight of the image-capturing touch panel or add other functions. Other side-detection touch device may also be used such as optical touch device, acoustic wave touch device, etc.

### Example 5

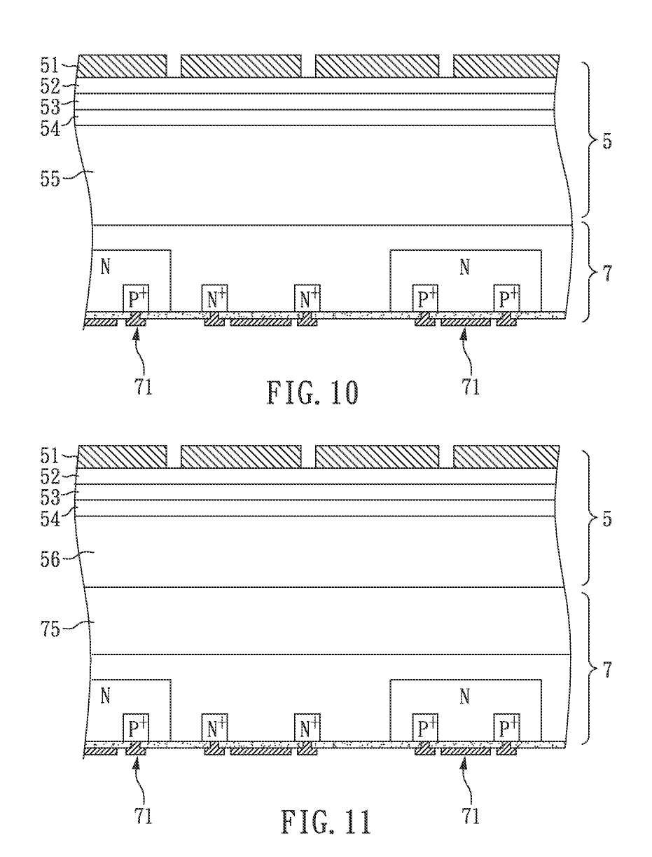

As shown in FIG. 10, the image-capturing touch panel of the present example is roughly the same as that of example 1, except that a CMOS (complementary metal oxide semiconductor) is used in the present example for substituting the CCD (charge-coupled device). Besides, the display device 5 in the present example locates at a surface of the substrate 55, and the light-sensor units 71 of the image-capturing device 7 locate at another surface of the substrate 55. The light-sensor units 71 of the image-capturing device 7 are directly set on the substrate 55 of the display device 5, and therefore an additional substrate is not needed so the thickness and weight of the image-capturing touch panel can be decreased.

Also, in another example, for the convenience of the process, the light-sensor units 71 of the image-capturing device 7 can be preformed on a substrate, then the substrate is placed (with image-capturing device 7 formed thereon) adjacent to the substrate of the display device 5. For example, as shown in FIG. 11, the light-sensor units 71 locate on the second substrate 75, and the display device 5 locates on the first substrate 56. Therefore, the image-capturing device 7 and the display device 5 can be prepared separately before the combination process. The process steps are simple and the process yield can be increased. However, the thickness of the whole image-capturing touch panel is increased. Hence, depending on the need, a proper structure between the ones shown in FIGS. 10 and 11 should be chosen.

The image-capturing touch panel of the present invention comprises an image-capturing device distributing at the whole surface of the display device, and therefore is able to provide very-short-distance image capturing. Specifically, the image-capturing touch panel of the present invention comprises an image-capturing device having light-sensor units distributing at the whole lower surface of the display device. In detail, for the image-capturing touch panel of the present invention, a touch device locates on the display device, the image-capturing device comprises multiple light-sensor units uniformly distributing on the surface of the stack so as to realize whole surface image capturing. Therefore, a scanning bar of a conventional laptop can be eliminated. The image-capturing touch panel of the present invention therefore has the advantages of being small in size, lightweight, compactness, etc, and may possess a higher economical value compared to the conventional touch displays.

Although the present invention has been explained in relation to its preferred embodiment, it is to be understood that many other possible modifications and variations can be made without departing from the spirit and scope of the invention as hereinafter claimed.

What is claimed is:

1. An image-capturing touch panel, which comprises:
a display device;
a touch device locating at one side of the display device; and
an image-capturing device locating at the other side of the display device, and the image-capturing device comprises multiple light-sensor units;
wherein the display device and the image-capturing device are both in a shape of sheet, the light-sensor units are uniformly distributed in the image-capturing device, the display device and the image-capturing device are stacked to form a stack, and the display device and the image-capturing device are transparent display device and transparent image-capturing device respectively.

2. The image-capturing touch panel as claimed in claim 1, wherein the touch device is a side-detection touch device locating at a corner of the display device.

3. The image-capturing touch panel as claimed in claim 1, wherein the touch device is a light-transmitting touch sensor and is stacked with the display device and the image-capturing device, and the display device is located between the touch device and the image-capturing device.

4. The image-capturing touch panel as claimed in claim 1, further comprises a process controller locating at the side of the stack and is independently electrically connected to the touch device, the display device, and the image-capturing device.

5. The image-capturing touch panel as claimed in claim 4, wherein the process controller comprises a process unit and a controlling unit.

6. The image-capturing touch panel as claimed in claim 5, further comprises a camera module located at the side of the stack.

7. The image-capturing touch panel as claimed in claim 6, further comprises a detecting unit for detecting the distance between the image-capturing device and an object to be captured, the detecting unit determines either the camera module or the image-capturing device is operated.

8. The image-capturing touch panel as claimed in claim 7, further comprises a light-source located at the side of the stack, in which the detecting unit detects the brightness of the object to be captured and determines whether the light source is turned on or off.

9. The image-capturing touch panel as claimed in claim 1, wherein the display device is a light-emitting diode display, and the light-emitting diode display comprises a substrate and multiple light-emitting diode units; or the display device is an organic light-emitting diode display.

10. The image-capturing touch panel as claimed in claim 1, wherein the display device locates on a substrate, and the multiple light-sensor units of the image-capturing device locates on the substrate.

11. The image-capturing touch panel as claimed in claim 1, wherein the display device locates on a first substrate, the image-capturing device locates on a second substrate, and the plural light-sensor units of the image-capturing device locates on the second substrate.

12. The image-capturing touch panel as claimed in claim 1, wherein the plural light-sensor units are one selected from CMOS (complementary metal oxide semiconductors) and CCD (charge-coupled device).

13. The image-capturing touch panel as claimed in claim 1, further comprises a frame set to surround the stack.

14. The image-capturing touch panel as claimed in claim 1, wherein the surface area of the plural light-sensor units is 10% to 90% of the surface area of the image-capturing device.

15. The image-capturing touch panel as claimed in claim 1, wherein the surface area of the display device is the same as the surface area of the image-capturing device.
